(19) United States
(12) Patent Application Publication
(10) Pub. No.: US 2024/0020627 A1
(43) Pub. Date: Jan. 18, 2024

(54) Sparse Data Driven Inventory Intelligence for Optimizing Traditional Trade

(71) Applicant: Windy Hill Pte. Ltd., Singapore (SG)

(72) Inventors: Muhammad Daffa Robani, Antapani (ID); Ying Li, Bellevue, WA (US)

(21) Appl. No.: 17/865,582

(22) Filed: Jul. 15, 2022

(51) Int. Cl. G06Q 10/08; G06Q 30/02

(52) U.S. Cl. CPC G06Q 10/087; G06Q 30/0201

(57) ABSTRACT

A stock or inventory intelligence and optimization system may operate in environments where there is sparse, incomplete, or even insufficient data. The recommendation system may use estimated sales data, sales growth rate, SKU variety and diversity, and warehouse size to calculate an adjusted inventory turnover metric. This metric, even when derived from incomplete or sparse data, gives a meaningful metric that can be used in several use cases. Merely knowing the input or output of products for a business can be sufficient to generate recommendations about product mix, generate performance metrics about the business performance to compare with other similar businesses, detect fraud and creditworthiness, as well as generate useful dashboards for managing a business.

### BACKGROUND

Some inventory systems operate with a “comprehensive” data set. These systems count every item added to inventory and every item that leaves. Such systems rigorously and tediously scan each item added to inventory and each item that is removed.

Such systems are prevalent in modern grocery stores or larger retail stores, for example, where inventory is scanned using a barcode scanner at check out to decrement inventory by the amount purchased.

In theory, this type of comprehensive inventory management system should lead to highly accurate inventory data, yet every retailer goes through a monthly or quarterly inventory reconciliation process to update the actual inventory. Inventory discrepancies may occur due to shrinkage, such as product spoilage, theft, or damage, as well as through human error and system errors. Even though these systems are thought to be “accurate,” there are always some discrepancies that enter into the picture.

There are many environments where such systems are not available or not practical. For example, a wholesale supplier to a merchant may not have access to the merchant's inventory management system. In some cases, a merchant may operate without a sophisticated inventory management system—or without any inventory management system at all.

In such situations, “accurate” inventory data do not exist, making conventional business metrics unavailable or unreliable.

### SUMMARY

A stock or inventory intelligence and optimization system may operate in environments where there is sparse, incomplete, or even insufficient data. The recommendation system may use estimated sales data, sales growth rate, SKU variety and diversity, and warehouse size to calculate an adjusted inventory turnover metric. This metric, even when derived from incomplete or sparse data, gives a meaningful metric that can be used in several use cases. Merely knowing the input or output of products for a business can be sufficient to generate recommendations about product mix, generate performance metrics about the business performance to compare with other similar businesses, detect fraud and creditworthiness, as well as generate useful dashboards for managing a business.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a schematic illustration of an embodiment showing a wholesale supplier and retail merchant interaction.

FIG. 2 is a diagram illustration of an embodiment showing a network environment with a supplier system and merchant system.

FIG. 3 is a flowchart illustration of an embodiment showing a method for interaction between a supplier and merchant.

### DETAILED DESCRIPTION

Business Analysis Systems Using Noisy or Incomplete Data

So-called “sophisticated” inventory management systems attempt to manage business operations by the tedious and time-consuming checking in and out of items in inventory. This may occur in warehouses, wholesale suppliers, as well as a merchant's retail store. While generally considered to be the “gold standard” of inventory management, such systems are not infallible. Shrinkage due to spoilage, damage, theft, misplacement, human error, and other problems cause these systems to not have 100% accuracy.

Such systems are often used by business managers to manage inventory, make purchasing decisions, and to monitor sales and profitability. However, most such systems assume 100% accuracy of the data in order to operate effectively.

Many business environments exist where inventory information is not available, incomplete, or where the data are not reliable or accurate.

Many useful business metrics may be inferred or derived from “incomplete” data. These metrics include various general business metrics, such as inventory turnover, as well as individual Stock Keeping Unit (SKU) analyses. Even without tracking both the receipt and sales of an SKU, inferences may be made about the inventory of that SKU based on either just the purchase history or the sales history.

By measuring either receipt or sales of a set of SKUs, general inferences about the business performance may also be made. These inferences, such as adjusted inventory turnover, represent the general performance of a business.

Two Types of Analyses

Two general types of analyses may be performed with a single data set. The data set may be the sales data from one wholesale supplier. This data set may include sales to multiple retail merchants.

From this data set, one set of metrics may be generated to analyze the wholesale supplier's business. These metrics may estimate the supplier's inventory turnover, identify high performing Stock Keeping Units, and other metrics.

Another set of metrics may be generated for the retail merchants who are customers of the wholesale supplier. Similarly, these metrics may include an estimate of the retail merchant's inventory turnover, performance metrics for various SKUs, and other metrics.

In many cases, a retail merchant may purchase wholesale goods from several different wholesale suppliers. In such instances, the estimates of the retail merchant's business metrics may be limited by the SKU data for products purchased from the wholesale supplier. Nonetheless, these metrics may be useful in many ways. including validating the business performance of the merchant, creditworthiness, SKU basket recommendations, and other use cases.

Use Cases for Business Metrics Derived from Incomplete Data

One use case for such derived business metrics may be for smaller merchants that do not have sophisticated inventory management systems. Such merchants might sell in a farmer's market, flea market, or other cash-based or informal retail setting. Other examples may be small, family-run merchants in developing or third world countries where sophisticated point of sale systems are not in widespread use. Many such merchants operate on a cash basis with poor or non-existent accounting systems.

Suppliers to these merchants can monitor the merchant's purchasing behavior and estimate the merchant's relative business performance. A supplier to these merchants may use the derived business metrics in several ways.

In one example, a supplier may offer a dashboard to the merchant that shows the merchant's business performance. This dashboard may give the merchant a running history of their business without any further information provided by the merchant. In some cases, a merchant may be able to provide some data back to the supplier, so that the dashboard may be updated with more accurate information. For example, a merchant may provide periodic inventory data for the number of items on a shelf. This small piece of information may update the inferred inventory levels on the dashboard.

A supplier may be able to offer such a dashboard based on the purchase history of the merchant, without any other source of data. A wholesale supplier may have a system that tracks purchases by their retail merchants, and such data may be sufficient to infer the merchant's performance. By offering such a dashboard, a merchant may be given insights into their business similar to insights from a sophisticated inventory and point of sale system, but without any additional work on their part.

In another example, inferred or derived business metrics may be used for recommending changes to a merchant's SKU “basket,” including recommending higher or lower volumes for specific SKUs, introducing new SKUs, bundling certain SKUs together, and other recommendations.

The inferred performance of individual SKUs may uncover those SKUs that are profitable for a merchant and those that are not as profitable. In many cases with merchants that do not have sophisticated inventory and point of sale systems, merchants may not realize which products they sell are generating the most profits.

A recommended basket of SKUs may add more profitable products for the merchant and suggest removing those SKUs which are less profitable.

Fraud Detection and Creditworthiness

Another use case for business metrics derived from incomplete data may be to identify fraud. Fraud or other abnormalities may happen intentionally or unintentionally in cash-based small businesses, especially when bookkeeping is poor or non-existent.

Fraud or other abnormalities may be detected by comparing derived inventory and business-performance metrics from a different data source and comparing those metrics to data provided by a merchant. When there are large discrepancies, a problem may be indicated, which may prompt an investigation into the issues.

Similarly, derived inventory and business-performance data may be used to determine a merchant's creditworthiness. A supplier, for example, may extend credit to a merchant whose purchasing data can be used to estimate the merchant's adjusted inventory turnover. This and other metrics may be input into a credit analysis to determine how much credit can be extended to the merchant.

Such a creditworthiness evaluation may come from sales data of a supplier, not from the merchant. In many cases, the merchant's books may be requested, but those books may be validated by comparing to inferred or derived business metrics that came from the supplier's records.

Aggregation of Data

The implied or derived business metrics may become more valuable when combined with similar metrics from many suppliers or merchants. In one use case, a wholesale supplier may track the business performance of all their retail merchants to know which merchant is performing well, and which are performing poorly.

A wholesale supplier may give feedback and recommendations to their retail merchants on how to improve sales, such as by changing the SKU mixture being sold, sharing best practices from the high performing merchants, or other improvements.

Improvement to Computer Systems

The recommendation system may be operated on a computer system, and, in some cases, may be implemented using software. It should be noted that when such a recommendation system is implemented on a general-purpose computer system, that the general-purpose computer system is transformed or changed to perform new and different functions than have never been previously performed by such systems. The recommendation system, when implemented on a computer system, changes the behavior and usefulness of the computer system, and the changes create functionality that has not been previously realized from such systems.

The recommendation system may further increase the performance of a general-purpose computer system for business analyses, since the general-purpose computer system may perform business analyses in a less optimal manner prior to implementing the recommendation system.

The analyses performed by a computer system for inventory analyses, SKU recommendations, querying merchants and re-calculating statistics, and other functions described herein become meaningful when performed at scale. Statistics gathered and analyzed for large numbers of SKUs, large numbers of merchants, and large numbers of baskets, when done manually become cumbersome, difficult to perform. Manual calculations lose much of their usefulness because computer systems enable real time or near-real time analyses to be performed, which are not possible if the calculations were done manually.

When done on a computer system, such analyses become nearly instantaneous, making them commercially useful. Without a computer system, such analyses are not commercially valuable because of the time delay of manual calculations and because of the sheer volume of calculations. Recommendation systems may process tens of thousands of transactions a day, with each transaction comprising a thousand SKUs. Such systems, when implemented on a computer, create datasets and analyses that are not possible or commercially practical using manual systems.

Merchant Basket Features

A supplier may be capable of monitoring what products may be sold to a merchant. In many cases, a merchant may purchase a “basket” of items periodically. Presumably, the merchant sells the items to their retail customers, however, the supplier may not have access to a merchant's point of sale system. In some cases, a merchant may not have a point of sale system or other mechanism to count each retail transaction.

From the basket of items, certain features of the basket may be computed. These include SKU variety, SKU entropy, SKU diversity, and SKU concentration. These factors may be used to compute the basket consistency and variability over time.

Basket Features

A basket may refer to a collection of SKU items along with the corresponding quantities on an invoice of a purchase transaction. For each basket, the SKU items in the basket generally have the corresponding units and prices.

Given any basket, there are several interesting features that can be calculated. These include SKU variety, SKU entropy, SKU diversity, and SKU concentration. When analyzing baskets over time, basket consistency and basket variability may also be calculated.

Let S be the collection of all SKU items that a system may work with. It is a set, and let N denote the number of distinct SKU's in the collection, |S|=N. B=(s₁, s₂, . . . , sₙ) denotes a basket that contains n SKU items, sᵢ∈S for i=1, 2, . . . , n. B denotes the space of all baskets.

SKU variety for a basket is defined as the number of distinct SKUs in the basket. The distinctness is based on the SKU identity as recorded in a transaction database.

SKU entropy for a basket B={s₁, s₂, . . . , sₙ} is

$$E ( B ) = - {\sum }_{i = 1}^{n} {p}_{i} \times {log}_{2} ( {p}_{i} )$$

where ρᵢ is the proportion of SKU item sᵢ in basket B.

SKU diversity for a basket B is defined as the normalized entropy of B. Specifically,

$$D ( B ) = - \frac{{\sum }_{i = 1}^{n} {p}_{i} \times ( {p}_{i} )}{( {\sum }_{i = 1}^{n} I ( {p}_{i} ) )}$$

where I(ρ) is the unit function.

SKU Concentration is the proportion of total quantities of a SKU item in the basket. If measured over time, e.g., multiple transactions over time, it reflects how a merchant favors certain SKU items or brands. Specifically, for a basket B=(s₁, s₂, . . . , sₙ) with corresponding quantities q=(q₁, q₂, . . . , q₂n), the top-3 concentration is computed as follows:

$$CC ( B , 3 ) = \frac{\begin{matrix}{\sum }_{i = 1}^{3} & ranked {( q )}_{i}\end{matrix}}{{\sum }_{i = 1}^{n} {q}_{i}}$$

To characterize changes in baskets over time, the basket features may be compared over a short period of time and a longer time. For example, a comparison may be made between baskets over a week compared to baskets over a month.

The consistency may be computed as:

$$CS ( M ) = 1 - \sqrt{\frac{{( {D}_{w} - {D}_{m} )}^{2} + {( {CC}_{w} - {CC}_{m} )}^{2}}{2}}$$

where M represents the merchant, D_{w} and Dₘ denotes the SKU diversity over a short period of time and a long period of time, respectively. Similarly, C_{w} and Cₘ represent SKU concentration over short and long time periods, respectively.

Given a collection of baskets B={B₁, B₂, . . . , B_{K}} with associated date of transaction {day₁, day₂, . . . , day_{K}} in chronological order. For each SKU item s in B, let the day gap between baskets that contains SKU item s be g=(g₁, g₂, . . . , gₖ), k≤(K−1) because item s may not appear in all K baskets.

The time variability of SKU item s in the collection of basket B is computed as:

tvb(B,s)=IQR(g)
where IQR stands for inter-quartile range.

The overall time variability of the collection of baskets B can be computed as

IQR(tvb(B,s₁),tvb(B,s₂), . . . ,tvb(B,sₙ))

or

Average(tvb(B,s₁),tvb(B,s₂), . . . ,tvb(B,sₙ))
where {s₁, s₂, . . . , sₙ} are the SKU items in the collection of baskets B.

Given a collection of baskets B={B₁, B₂, . . . , B_{K}}, for each SKU item i in B, let the quantities of SKU item s in all baskets be q=(q₁, q₂, . . . , qₖ), k≤K because item s may not appear in all K baskets.

The quantity variability of SKU item s in the collection of baskets B is computed as

qvb(B,s)=IQR(q)

Given a collection of baskets B={B₁, B₂, . . . , B_{K}}, the overall variability of basket collection B is computed as

$$VB ( B ) = \frac{TVB ( B ) \dot{Q} VB ( B )}{\vert TVB ( B ) \vert \times \vert QVB ( B ) \vert}$$

$$where$$

$$TVB ( B ) = ( tvb ( B , {s}_{1} ) , tvb ( B , {s}_{2} ) , … , tvb ( B , {s}_{N} ) )$$

$$QVB ( B ) = ( qvb ( B , {s}_{1} ) , qvb ( B , {s}_{2} ) , … , qvb ( B , {s}_{N} ) )$$

for all SKU items in S.

Inventory Turnover Computation

Let S be the collection of all SKU items that our system contains. It is a set, and let N denote the number of distinct SKU's in the collection, |S|=N. Let T be the observation time period, started from t_{b} until t_{ƒ}. I^{T}=(s₁, s₂, . . . , sₙ) denotes an inventory set held by a wholesaler/merchant in the observation period T that contains n SKU items, sᵢ∈S, for i=1,2, . . . , n. Furthermore, I_{w} and Iₘ denotes an inventory set held by a wholesaler and a merchant respectively.

Sold quantity of a SKU s at time t is denoted as SQₛ^{t} and is computed as

SQ_{S}^{T}=ΣₜSQₛ^{t}|t∈T

Whereas sold amount of SKU s in the observation time period T, denoted as SA_{S}^{T} and is computed as

SA_{S}^{T}=SQ_{S}^{T}×SP_{S}^{T}
where SP_{S}^{T} is the average selling price for SKU s in T.

The average quantity of SKU s at time t is denoted as AQₛ^{t}. It is computed as

$${AQ}_{s}^{t} = \frac{{BQ}_{s}^{t} + {EQ}_{s}^{t}}{2}$$

where BQₛ^{t} and EQₛ^{t} denote the beginning quantity and ending quantity of SKU s at time t respectively. The average quantity of SKU s in the observation time period T, denoted as AQ_{S}^{T}, is computed as

AQ_{S}=Average{AQtₛ^{t}|t∈T,t≥TI_{S}^{T}}
where TI_{S}^{T} is the initial time SKU s held by the wholesaler in the period T. The average amount of SKU s in the observation time period T, denoted as AA_{S}^{T} is obtained by

AA_{S}^{T}=AQ_{S}^{T}×SP_{S}^{T}
where SP^{T}_{S} is the average selling price for SKU s in T.

Inventory turnover for the wholesaler in the observation time period T, denoted as ITT, is computed as

$${IT}_{w}^{T} = \frac{{TSA}^{T}}{{TAA}^{T}}$$

where TSA^{T} is the total sold amount of the wholesaler in the period T, computed as

TSA^{T}=ΣₜSA_{S}^{T}|t∈I_{W}^{T}
and TAA^{T} is the total average amount of the wholesaler in the period T, computed as

TAA^{T}=ΣₛAA_{S}^{T}|s∈I_{W}^{T}

Inventory turnover for each SKU s in I_{W}^{T}, denoted as IT_{S}^{T}, can be computed as

$${IT}_{s}^{T} = \frac{{SA}_{s}^{T}}{{AA}_{s}^{T}}$$

Adjusted Inventory Turnover

Inventory turnover is a common measure to assess inventory productivity, to be more precise, by comparing its values across retailers or within themselves over time. However, many studies have showed that utilizing inventory turnover per se for this performance analysis might be not wise, as the values are likely to be influenced several variables of a retailer. It was observed that gross margin, capital intensity, sales surprise, company size, and sales growth rate can be significant in affecting inventory turnover ratios in the retail industry.

In a situation where a supplier has merely its own data of sales to a merchant, a supplier may estimate or approximate inventory turnover using data available to the supplier. In a conventional or classical analysis, a merchant's sales data may accurately measure and calculate inventory turnover.

Many situations exist where a merchant's data may not be available. For example, some merchants may not have a point of sale system or other computerized inventory system. Such merchants may be mom-and-pop retailers, weekend or hobbyist retailers who have informal operations, such as in a flea market or farmer's market. In less developed countries, many merchants, bodegas, restaurants, or other retailers operate without sophisticated inventory tracking systems.

In such cases, suppliers may be able to provide sophisticated business metrics bases on their sales to a merchant. The observations of sales to a merchant, tracked over time, can be used to estimate an adjusted inventory turnover.

Therefore, they suggested to use a new empirical measure, adjusted inventory turnover (AIT), to control the effects of those variables to IT ratios, which lead to a more fair measure for inventory performance comparison.

Business size, denoted as BS, is represented by total amount of sales of in the previous period.

BS^{T}=SA^{T-1}

Sales growth rate, denoted as SG, is computed by comparing current to the previous total amount of sales.

$${SG}^{T} = \frac{{SA}^{T}}{{SA}^{T - 1}}$$

SKU variety, denoted as V, is defined as the number of distinct SKUs held by the wholesaler/merchant in the period T, I^{T}.

SKU diversity, denoted as D, for an inventory set I^{T}=(s₁, s₂, . . . , sₙ) is specified as

$${D}^{T} = - \frac{{\sum }_{i = 1}^{n} {p}_{i} \times {p}_{i}}{( \begin{matrix}{\sum }_{i = 1}^{n} & I ( {p}_{i} )\end{matrix} )}$$

where ρᵢ is the proportion of SKU item sᵢ average amount, AA_{S}^{T} compared to the total average amount, TAA^{T}. I(·) is a unit function.

Warehouse size, denoted as WS, is represented by the total average amount in the given period:

WS^{T}=TAA^{T}

Adjusted Inventory Turnover Model

A log-linear regression model may specify the relationship between variables. Precisely, we use this following log-linear model:

log ITᵢₜ=cₜ+bₜ¹ log BSᵢₜ+bₜ² log SGᵢₜ+bₜ³ log Vᵢₜ+bₜ⁴ log Dᵢₜ+bₜ⁵ log WSᵢₜ+ϵᵢₜ

Where cₜ is the time-specific fixed effect for period T, b¹, b², b³, b⁴, and b⁵ are the time-dependent coefficients for log log B Sᵢₜ, log log S Gᵢₜ, log log Vᵢₜ, log log Dᵢₜ, and log log W Sᵢₜ, respectively. ϵᵢₜ is the error term between the observation to the model.

This equation provides a tradeoff curve between the expected inventory turnover of a wholesaler/merchant for their values of those control variables.

The adjusted inventory turnover may be computed as,

log AITᵢₜ=log ITᵢₜ−bₜ¹ log BSᵢₜ—bₜ² log SGᵢₜ−bₜ³ log Vᵢₜ−bₜ⁴ log Dᵢₜ−bₜ⁵ log WSᵢₜ

or

AITᵢₜ=ITᵢₜ(BSᵢₜ)^{-b}^{ₜ}^{¹}(SGᵢₜ)^{-b}^{ₜ}^{²}(Vᵢₜ)^{-b}^{ₜ}^{³}(Dᵢₜ)^{-b}^{ₜ}^{⁴}(WSᵢₜ)^{-b}^{ₜ}^{⁵}

This adjusted value can then be utilized as a measure for inventory performance comparison, either across wholesalers/merchants or across periods by controlling the values of the control variables.

The equation for the Adjusted Inventory Turnover reflects an estimated business performance based on the factors that a supplier can readily measure. Because the supplier does not have access to a merchant's point of sale system or a merchant may not even maintain a point of sale system, the supplier may, nonetheless, be able to monitor the merchant's business performance.

Wholesale Supplier's Inventory Turnover Computation

A wholesale supplier's inventory turnover computation may be made by creating a simulation based on observed sales, then optimizing the simulation to determine estimated or approximate values for inventory turnover.

For SKUs, osq is an array to store the sold quantity for each time index t, as:

osq={osq_{{1}},osq_{{2}}, . . . ,osq_{{T}}}
where T is the length of the period.

The inventory may be simulated by following a (s, S) inventory policy, where s is the reorder level and S is the target inventory level. Under this policy, an order to replenish the stock is placed when the inventory level has reached or below s, so that the inventory level would reach S again. The simulation may use an initial quantity of the SKU, IQ, and the lead time, LT, which describes how many days the stock would arrive after the order was placed.

Given the simulation parameters, the beginning inventory level and ending inventory level at each t can be estimated. Each inventory level, that is stored in bq and eq respectively, as:

bq is an array to store the beginning quantity at each t as:

bq={bq_{{1}},bg_{{2}}, . . . ,bq_{{T}}}

Similarly, eq is an array to store the ending quantity at each t as:

eq={eq_{1},eq_{2}, . . . ,eq_{T}}
where T is the length of the period.

The estimated values of bq and eq may be acquired by running a simulation where the input data are the array osq and parameters s, S, IQ, and LT.

The output are the arrays bq and eq.

For each time period, bq and eq may be updated to subtract any sales from the current time period. If the inventory falls at or below s, the inventory is replenished to S.

The result is a sequence of bq and eq arrays that simulates the inventory levels over each instance of time. A constrained optimization analysis using the recorded transaction data SQ. The optimization problem can be defined as:

S

s.t.eq_{t}≥0|t∈T

s=k×S

IQ=S

LT=LT_{arb}

The optimization problem may be done to find the lowest values of S, while satisfying the recorded transaction data, i.e., there are no negative values of ending inventory level. The problem may be defined by assuming the wholesaler would have the lowest possible target inventory level S, as for their limited warehouse size and storage cost. Moreover, there are also arbitrary parameters to control the optimization: k is the proportion of s to S, and LTarb is a defined arbitrary lead time.

These parameters are chosen to approximate the actual inventory levels and lead time appropriate for the business. Typically, such parameters may be based on observations of the actual business.

The analysis above assumes that there is no shrinkage, stolen items, mis-entered data, or other problems. Even with modern point of sale systems, there are transactions that may not be captured. The mathematical model may be configured to learn from unobserved sales and inventory losses when given transactions and inventory level updates.

Inventory may be physically counted at various intervals for each SKU. These updates may be stored in an array q as well as a time of the update, t.

q_{{u}}={q_{{u,1}},q_{{u,2}}, . . . ,q_{{u,M}}}

t_{{u}}={t_{{u,1}},t_{{u,2}}, . . . ,t_{{u,M}}}
where M is the number of inventory updates.

Unobserved sales and inventory losses can be explained by US and IL random variable, respectively. Random variable is used since it may be likely that relatively few inventory updates may be available.

Unobserved sales may be a truncated normal distribution that is related to the observed sales. A part of the analysis assumes that inventory values may not be negative.

The random unobserved sales US may be defined as

US=0≤N(μ_{{us}},σ_{{us}})≤(bq−osq)
where μ_{{us}} and σ_{{us}} may be mean and standard deviation of the distribution, respectively.

μ_{{us}}=c_{{1}}×sq+c_{{2}}

where c1 represents the expected proportion of unobserved sales to the observed sales. c2 is an intercept parameter used to allow the occurrence of unobserved sales even when there are no recorded transactions. Assuming the distribution has a constant coefficient of variance across input spaces, σ_{{us}} can be defined as:

σ_{{us}}=CV_{{us}}×μ_{{us}}
where CVus is the constant coefficient of variance for the distribution.

Inventory losses IL is specified as a Bernoulli distribution in some cases. Inventory losses may be defined as:

IL=B(λ)×c₃×(bq−osq−usq)
where λ is the probability of the inventory loss occurring and c3 is the proportion of the inventory loss to the current inventory level, which is the beginning inventor level minus the observed and unobserved sales.

Similar to the previous simulation, the beginning and ending inventory levels may be estimated by running a similar simulation, but with random variables US and IL. The beginning and ending inventory levels may also be in the form of random distributions.

Such a simulation may have two types of parameters. One type are the simulation parameters such as the target inventory level S, reorder inventory level s, and initial inventory level IQ. The second type may be the random variables c1, c2, cv, c3, and λ. In order to estimate these variables, a constrained multi-objective optimization may be performed using recorded data sq and updated inventory level data q.

The optimization problem may be defined as:

S

L(qᵤ,eq)

s.t.eq_{t}≥0|t∈T

s=k×S

IQ=q_{u,1}

Here, the optimization may be performed to minimize the target stock S while satisfying the recorded data. An objective function maximizes the likelihood of simulated inventory levels to the received actual inventory level updates L(qu, eq). The optimized parameters may generate the most likely simulated inventory levels in explaining transaction and updated inventory levels data.

A parameter CVqu may represent the inaccuracy of the inventory level updates. The likelihood may be evaluated on a distribution as L(N(qᵤ, CV_{qu}qᵤ), eq).

Using the optimal parameters and the updated inventory levels data, the simulated inventory levels may be inferred. This can be achieved by performing a large number of simulations, then finding the simulations that best match the distribution of actual inventory levels, N(qᵤ, CV_{qu}qᵤ).

Further, simulated inventory levels before and after the last inventory level updates within a period. These inventory levels may be later used for inventory turnover computation. This gives the total estimated sold quantities by adding the observed and unobserved sold quantities.

Inventory turnover computation.

Computing inventory turnover for each SKU can be done with the estimated values of beginning and ending inventory of each time period, which is often one day.

An array may store the selling amounts

sα={sα_{{1}},sα_{{2}}, . . . ,sα_{{T}}}

sαᵢ=sqᵢ×spᵢ
where sp is the selling price of a SKU.

ba may be an array to store the beginning amounts

bα={bα_{{1}},bα_{{2}}, . . . ,bα_{{T}}}

bαᵢ=bqᵢ×spᵢ

ea may be an array to store the ending amounts

eα={eα_{{1}},eα_{{2}}, . . . ,eα_{{T}}}

eαᵢ=eqᵢ×spᵢ

The average amount held by a wholesale supplier for each SKU, AA can be computed as

$$aa = \{ {aa}_{\{ 1 \}} , {aa}_{\{ 2 \}} , … , {aa}_{\{ T \}} \}$$

$${aa}_{i} = \frac{{bq}_{i} + {sa}_{i}}{2}$$

The average amount held by the wholesaler during a period, AA may be computed by averaging the values in aa as

$$AA = \frac{\begin{matrix}{\sum }_{i}^{T} & {ee}_{i}\end{matrix}}{T}$$

The total sold amounts for each SKU by the wholesaler, SA may be

$$SA = \begin{matrix}{\sum }_{i}^{T} & {sa}_{i}\end{matrix}$$

Inventory turnover IT may be defined as

$$IT = \frac{SA}{AA}$$

The overall inventory turnover for the wholesaler may be computed by summing all SKUs.

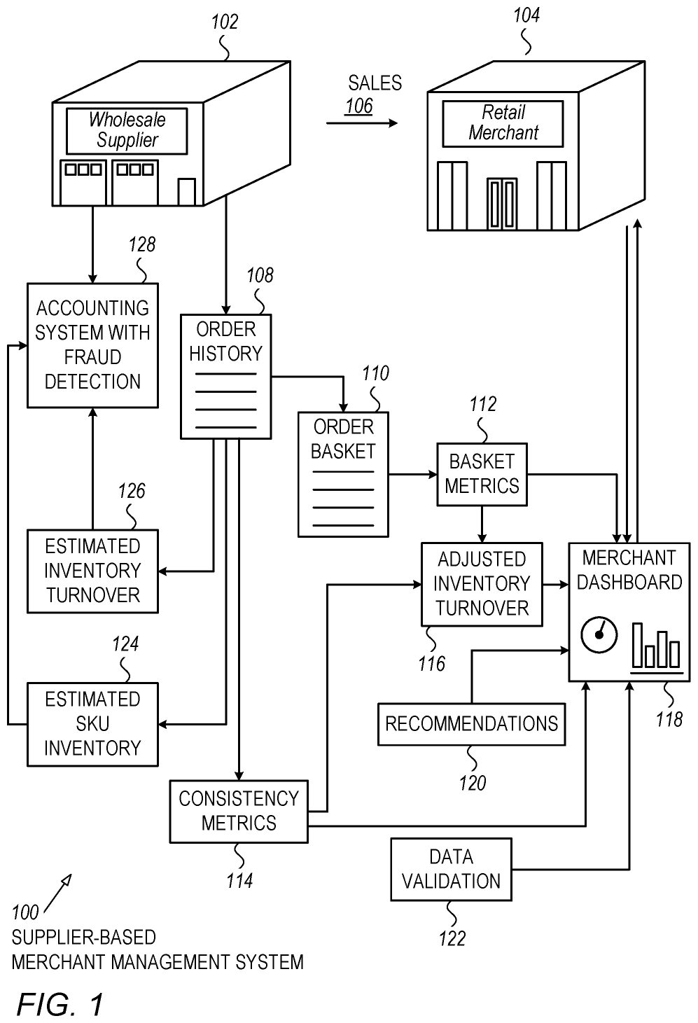

Throughout this specification and claims, the term “supplier” is used to denote a wholesale supplier of goods. The term “merchant” is used to denote the retail seller of goods. A “supplier” sells goods to a “merchant,” who then sells the goods to a consumer. FIG. 1 is a diagram illustration showing an example embodiment 100 of a supplier-based merchant management system. A wholesale supplier 102 sells to a retail merchant 104 on a periodic basis. These sales 106 are known to the supplier 102, however, the supplier 102 may not have access to sales information by the merchant 104.

Nonetheless, an order history 108 for the order baskets 110 sold by the supplier 102 to the merchant 104 can be the basis for estimating performance metrics for the merchant 104. These performance metrics may allow the merchant 104 to monitor their business performance, and may also be used by the supplier 102 to recommend products or changes to the baskets to help the retail merchant 104 be more successful.

From each order basket 110, various basket metrics 112 may be computed. These metrics may include the SKU diversity, SKU entropy, SKU variety, SKU concentration, and the like. Additionally, various consistency metrics 114, such as basket consistency and basket variability may be computed. The consistency metrics 114 may analyze how baskets may change over time.

The order history 108 may reflect the merchant's business operations. As a merchant purchases items again and again, an analysis may assume that the merchant has successfully sold those items. An analysis of the growth, stagnation, or decline of those sales over time may reflect the merchant's business growth, stagnation, or decline.

Because the supplier 102 may have many order histories 108 from many different merchants 104, the supplier's data may be instructive to assist merchants to find improved mix of SKUs that may help the merchant increase sales.

Many of the metrics calculated from the supplier's order history 108 may be presented in a merchant dashboard 118. The merchant dashboard 118 may be a computer interface through which the merchant 104 may access at least some of the metrics observed or implied from the baskets of SKUs purchased from the supplier 102.

The merchant dashboard 118 may be part of a larger application or computerized system for the merchant. Such a system may allow a merchant to place orders through a computerized interface, apply for financing or negotiate payment terms, or facilitate other interactions between the merchant 104 and supplier 102.

Additionally, a supplier 102 may provide recommendations 120 to the merchant 104 for current or future purchases. The recommendations 120 may be provided during the ordering process or at other times.

Because the supplier's data may be based solely on the order history 108, data validation 122 may ask various questions of the merchant 104 to update a model of the merchant's business performance. The data validation 122 may supplement the supplier's data by querying a merchant 104 about certain SKUs, for example. In one such example, the data validation 122 may ask the merchant 104 whether the stock of a specific SKU has run out. If the stock has not run out, the data validation 122 may ask how many items are still on the shelf.

The data validation 122 may cause the underlying assumptions to the various business models to be adjusted. One assumption, for example, in a baseline analysis is that a merchant 104 may order a SKU after that SKU has been depleted to zero items. However, some merchants may attempt to keep a minimum number of inventory on the shelf at any time. By analyzing the merchant's specific behavior, the mathematical models may be updated and may be more closely tailored to that specific merchant.

By using solely the order history 108, various estimated metrics may be generated about the business performance of the supplier 102. These estimated metrics may include estimated SKU inventory 124 as well as estimated inventory turnover 126, as described above.

These metrics may be compared against other accounting systems 128, which may help identify fraud, excess shrinkage, theft, or other abnormalities. Metrics generated from a conventional accounting system 128 may be validated, or not, by comparing to estimated metrics that may be generated merely from the sales data. When the estimated metrics are consistent with comparable metrics in a conventional accounting system, the conventional accounting system may be trusted.

Similarly, when the estimated metrics may be outside a predefined threshold, an alarm, alert, or other action may be taken. A discrepancy outside of a predefined threshold may indicate an accounting irregularity that may be investigated and tracked down. In many companies, a conventional accounting system may be trusted by default. One mechanism to validate conventional accounting systems may be to compare against estimated metrics that may be computed from solely the sales data.

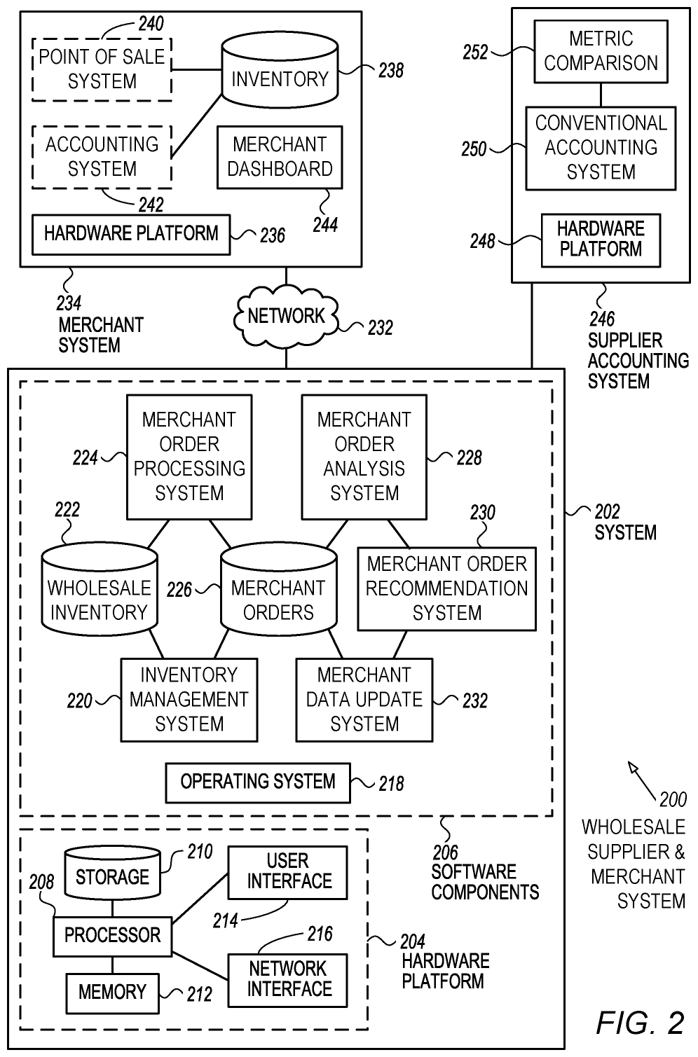

FIG. 2 is a diagram of an embodiment 200 showing components that may collect and analyze merchant purchase behavior to determine recommendations and provide a dashboard for merchants. The data may reflect baskets of goods purchased by a merchant from a supplier, and the supplier's records over time may provide useful information to the merchant. A system 202 may reflect an example system that may be operated by a wholesale supplier.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

A supplier's system 202 may have an inventory management system 220, which may manage the wholesale inventory 222 of the supplier. The inventory management system 220 may keep a count of current inventory by adding items into inventory as they are purchased or received, then decrementing items as they are sold to a merchant.

A merchant ordering system 224 may be a computerized interface through which a merchant may place an order with the supplier. In many cases, a computerized interface may list items available for purchase, and a merchant may indicate which items to purchase and the quantity of those items. The merchant ordering system 224 may create a basket of items, which may be pulled from physical inventory and prepared for the merchant.

In some cases, the merchant ordering system 224 may be a point of sale system. In such cases, a merchant may purchase items at the supplier's warehouse on the spot, without pre-ordering. In such cases, the merchant's order may be assembled and items being sold may be entered into a merchant order system 224 as those items are requested.

A database of merchant orders 226 may be created over time. Each merchant may place orders for baskets of SKUs, and the frequency of orders and the repeated nature of the orders may be analyzed to determine the merchant's successfulness. Such analysis may be performed by a merchant order analysis system 228.

A merchant order analysis system 228 may analyze merchant orders to characterize individual baskets of SKUs, as well as analyze the orders over time. The basket characterization may include SKU diversity and the like, and over time, metrics for how those baskets change will also be generated.

The merchant order analysis system 228 may analyze merchant orders from many different merchants. A single supplier may provide goods for many different merchants, and sometimes a single supplier may sell to hundreds or even thousands of merchants.

In many instances, a merchant order analysis system 228 may compare one merchant's order history to many other merchant's order history. Such a database may be a rich source of information for comparison and learning.

A merchant order recommendation system 230 may make recommendations to a merchant regarding the basket composition. The recommendation system 230 may identify SKUs that are not good performers and may recommend eliminating, replacing, or purchasing a smaller quantity of the SKU. In some cases, the recommendation system 230 may suggest an alternative SKU that may have been successful with other merchants.

The merchant order recommendation system 230 may suggest additional SKUs that have been successful with other merchants. One mechanism for such a recommendation is to find a similar merchant and to analyze the differences in SKUs between their baskets.

The similarity between one merchant and another may be based on their order history, quantity sold, frequency of replenishment, or other factors. Once a similar merchant may be identified, a recommendation system 230 may identify a particular SKU that the similar merchant has shown success in selling. A more strongly recommended item may have a high profit margin, high selling volume, or other economic factor by which the new SKU may be attractive.

A merchant data update system 231 may query a merchant on one or more data items. These updates may be used to update the merchant's business statistics as well as to refine the assumptions made while analyzing the merchant's business. For example, one assumption may be that a merchant orders a SKU the instant after selling the full amount in inventory. Such an assumption does not reflect reality, but the assumption simplifies the math. For example, using such an assumption, the merchant order analysis system 228 may calculate the average number of sales of a SKU per day as being the quantity purchased from the supplier divided by the number of days between orders.

In the example, the merchant may have sold out of an item very quickly, but operated with zero inventory for several days before placing a replenishment order. The merchant data update system 231 may ask the merchant directly if the SKU has sold out and when that occurred. In some cases, a merchant may order replenishment prior to running out of the product. In such a case, the merchant data update system 231 may ask the merchant to report the inventory at hand when they placed a new order.

The example is merely one use case for the merchant data update system 231. The merchant data update system 231 may identify questions to periodically ask of the merchant. Such questions may help a supplier update their model of a merchant's ordering and selling behavior.

A network 232 may connect a supplier's system 202 with a merchant system 234.

The merchant system 234 may operate on a hardware platform 236 and may include an inventory database 238, a point of sale system 240, and an accounting system 242. Some merchants may operate using a physical inventory system, meaning that they may keep pen and paper records of inventory, or they may merely look at the shelves to see how much product is available. Other merchants may have an automated or semi-automated system that checks in new inventory when received, and decrements inventory that may be sold. Some merchants may have an automated or computerized accounting system 242, which may track sales over time.

In some use cases, a merchant system 234 may be connected to a supplier system 202 to transfer point of sale data or accounting data to the supplier. Such a data transfer may be possible with sophisticated merchants that have computerized infrastructure. For many smaller merchants, such systems may not be available or useful.

A merchant dashboard 244 may be a user interface through which a merchant may view data and recommendations provided by the supplier system 202. The merchant dashboard 244 may include other features, such as an order placement system as well. In many cases, the merchant dashboard 244 may be a mechanism to communicate between a merchant and supplier, and two-way communications may be possible, such as with the merchant data update system 231 or other uses.

A supplier accounting system 246 may operate on a hardware platform 248 and have a conventional accounting system 250. The conventional accounting system 250 may take data from many sources, including sales data, inventory data, accounts payable, accounts receivable, banking information, and other sources.

In many cases, such accounting systems may be complex and may be accessed by a limited number of highly trained bookkeepers and accountants. Such a situation may place a great amount of trust or reliance on those people.

By independently calculating business metrics from sales data alone, the results of a conventional accounting system 250 may be validated. A metric comparison 252 may compare expected or estimated metrics from merchant purchases against the records of the conventional accounting system 250. When the estimated metrics and the conventional accounting system do not agree, an investigation may be warranted to find the source of the discrepancy. Such discrepancies may be difficult to detect without using metrics estimated solely from the supplier's sales data.

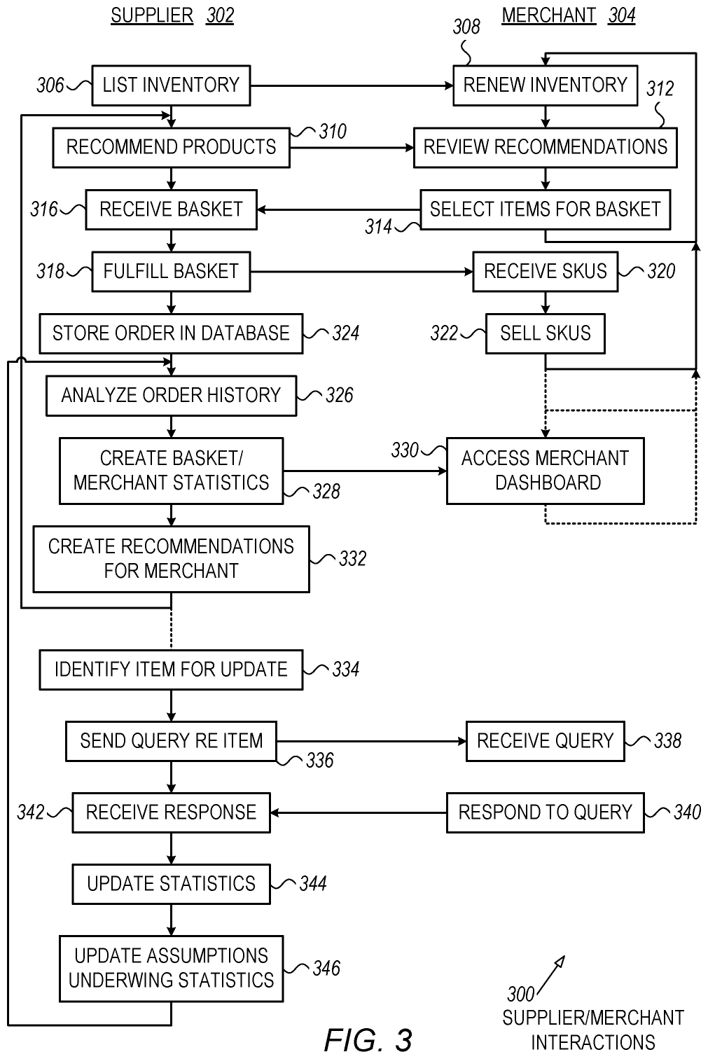

FIG. 3 is a flowchart illustration of an embodiment 300 showing a method of interacting between a supplier 302, shown on the left hand column, and a merchant 304, shown in the right hand column. The illustrated interactions represent typical functions that may be performed to track a merchant's order, as well as to make recommendations to the merchant and update data items for the supplier.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

The method of embodiment 300 may show a typical interaction where a supplier may offer items for sale and a merchant may select items. A history of sales from the merchant, as well as history of sales from other merchants, may be used to recommend changes to the merchant's baskets.

A supplier 302 may list inventory available on block 306, which a merchant 304 may review in block 308. The supplier 302 may also recommend products in block 310, which the merchant 304 may review in block 312. After reviewing the available inventory in block 308 and recommendations in block 312, the merchant 304 may select items for their basket in block 314.

The basket, as used here and other places in this specification and claims, refers to a single purchase of a retail merchant from a wholesale supplier. For some merchants, baskets of goods may be purchased daily, weekly, bi-weekly, monthly, or some other period. Some merchants may schedule basket purchases on another cadence, while some may purchase baskets of goods based on low inventory or other basis, and such purchases may be done on non-regular intervals.

The supplier 302 may fulfil the basket in block 318, and the merchant 304 may receive the SKUs in block 320 and proceed to sell the SKUs in block 322.

As the merchant 304 runs low on inventory or runs out of inventory, the merchant 304 may return to block 308 to make another purchase from the supplier.

The supplier 302 may store the order in a database in block 324. The order history may be analyzed in block 326 to create basket and merchant statistics in block 328. Some or all of the statistics may be made available to the merchant in block 330.

Based on the statistics and order history, the supplier 302 may create recommendations for the merchant in block 332. The recommendations may be fed back to block 310 for the next purchase cycle. In some cases, recommendations may be made through the merchant's dashboard. In such cases, the merchant's dashboard may be part of an application or computer interface through which purchases may be pre-ordered. Such applications or computer interfaces may provide other functionality as well.

The supplier 302 may be creating statistics and estimations of a merchant's business performance using incomplete data. Specifically, the supplier has data relating to the purchases made by the merchant, but does not have visibility into the merchant's actual sales.

An example is that the supplier estimates actual retail sales based on the merchant's re-purchase behavior of a SKU. In the example, two merchants may repurchase 100 of that SKU every week, and the supplier's statistics may show identical business performance. However, one merchant may sell out of the 100 units of the SKU in three days, while the other merchant may have an inventory of 10 units on hand at the end of the week when they reorder.

In the example, the first merchant may be better off ordering additional units of the SKU because their sales can support a higher level. The second merchant may order fewer units of the same SKU because their inventory carrying costs reduce business performance. Even though both merchants appear to be the same from the supplier's order history, the supplier may be able to assist the merchants through a recommendation system when the supplier has better insight and better data underlying the assumptions about the merchant's business performance.

A supplier 302 may request data from the merchant 304 to feedback into the statistics and business performance analysis for the merchant. The request may be simple questions about individual SKUs, about weekly/monthly/yearly sales, inventory management, or any other topic. A simple question may be similar to how long did it take to sell out of SKU? Another example may be how much of SKU did you have on hand last time you ordered?

In some cases, the queries may be more comprehensive or detailed. For example, an update may ask the merchant to list their current inventory on a basket of SKUs.

The data received from the merchant may help the supplier to update their statistics about the merchant's performance, as well as update the recommendations made to the merchant.

The supplier 334 may identify an item to update in block 334. A query may be sent in block 336, which may be received by the merchant 304 in block 338. The merchant 304 may respond to the query in block 340, and the response may be received in block 342. The supplier's statistics for the merchant may be updated in block 344, and any assumptions underlying the statistics may be updated in block 346. The statistics may be fed back to block 326, where the statistics may be updated.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A system comprising:
electronic access to a supplier database comprising historical sales data from a first supplier to a plurality of merchants;
at least one processor, said at least one processor configured to perform a method comprising:
receiving a first series of sales to a first merchant from said supplier database;
analyzing said first series of sales to said first merchant to determine a set of basket metrics for each of said sales in said first series of sales to said first merchant;
analyzing said set of basket metrics to determine a set of consistency metrics for said sales in said first series of sales;
analyzing at least said set of consistency metrics and said set of basket metrics to determine an adjusted inventory turnover metric; and
providing at least a portion of said basket metrics and at least a portion of said consistency metrics and said adjusted inventory turnover metric on a merchant dashboard accessible by said first merchant.

2. The system of claim 1, said method further comprising:
identifying a first Stock Keeping Unit (SKU) sold by said supplier to said first merchant;
querying said first merchant through said merchant dashboard to determine a first actual sales amount for said first SKU during a first time period and receiving said first actual sales amount;
updating said first series of sales and said adjusted inventory metric to include said first actual sales amount; and
updating said merchant dashboard accessible by said first merchant.

3. The system of claim 2, said method further comprising:
identifying a second merchant having a similar set of basket metrics as said first set of basket metrics for said first merchant;
comparing basket contents between said first merchant and said second merchant;
identifying a second SKU present in said basket contents of said second merchant that is not present in said basket contents of said first merchant; and
providing a first recommendation in said merchant dashboard for said first merchant, said first recommendation comprising said second SKU based on said basket contents of said second merchant.

4. The system of claim 3, said second merchant being further identified by having a sales growth performance higher than said first merchant.

5. The system of claim 4, said basket metrics comprising a SKU concentration metric.

6. The system of claim 4, said basket metrics comprising a basket consistency metric.

7. The system of claim 4, said second merchant being identified at least in part by calculating a similarity metric between a plurality of merchants and said first merchant, and selecting said second merchant at least in part based on a threshold of similarity between said first merchant and said second merchant.

8. The system of claim 1, said set of basket metrics being derived solely from said first series of sales.

9. A system comprising:
electronic access to a supplier database comprising historical sales data from a first supplier to a first merchant;
at least one processor, said at least one processor configured to perform a method comprising:
receiving a first series of sales to said first merchant from said supplier database;
based solely on said first series of sales, calculating a first estimated inventory level for a first Stock Keeping Unit (SKU);
providing said first estimated inventory level for said first SKU on a computer dashboard accessible by said first merchant;
receiving a first measured inventory level for said first SKU, said first inventory level being provided by said merchant;
updating said first estimated inventory level for said first SKU to a second estimated inventory level based on said first measured inventory level; and
providing said second estimated inventory level on said computer dashboard.

10. The system of claim 9, said method further comprising:
based solely on said first series of sales, calculating an estimated inventory turnover for said first merchant; and
providing said estimated inventory turnover on said computer dashboard.

11. The system of claim 10, said method further comprising:
generating a creditworthiness score for said first merchant based on said estimated inventory turnover.

12. The system of claim 11, said method further comprising:
sending a credit offer to said first merchant on said computer dashboard.

13. A system comprising:
electronic access to a supplier database comprising historical sales data for a plurality of Stock Keeping Units (SKUs) from a first supplier to a plurality of merchants;
at least one processor, said at least one processor configured to perform a method comprising:
based solely on said first series of sales, calculating a first estimated inventory level for each of said plurality of SKUs;
receiving a first inventory level for a first SKU, said first inventory level being a measured inventory level for said first SKU;
adjusting said first estimated inventory level for said first SKU to a second estimated inventory level for said first SKU;
determining an inaccuracy metric for said first SKU; and
when said inaccuracy metric is higher than a first predetermined threshold, issuing a first discrepancy alert for said first SKU.

14. The system of claim 13, said method further comprising:
based solely on said first series of sales, determining a first estimated inventory turnover;
receiving an accounting system inventory turnover metric generated from an accounting system of said first supplier;
determining a first inventory turnover error by calculating a difference between said first estimated inventory turnover and said accounting system inventory turnover metric;
when said first inventory turnover error is higher than a second predetermined threshold, issuing a second discrepancy alert.
